(19) United States
(12) Patent Application Publication
(10) Pub. No.: US 2026/0056154 A1
(43) Pub. Date: Feb. 26, 2026

(54) SENSOR

(71) Applicant: KABUSHIKI KAISHA TOSHIBA, Tokyo (JP)

(72) Inventors: Yosuke AKIMOTO, Yokohama (JP); Hiroshi HAMASAKI, Hiratsuka (JP); Yui YAMAZAKI, Tokyo (JP)

(73) Assignee: KABUSHIKI KAISHA TOSHIBA, Tokyo (JP)

(21) Appl. No.: 19/227,592

(22) Filed: Jun. 4, 2025

(30) Foreign Application Priority Data
Jul. 23, 2024 (JP) 2024-117728

(51) Int. Cl. G01N 27/12

(52) U.S. Cl. CPC G01N 27/128

(57) ABSTRACT

According to one embodiment, a sensor includes a base, a first structure fixed to the base, and a first detection section. A second direction from the first structure to the first detection section crosses a first direction from the base to the first detection section. The first detection section includes a first element portion including a first conductive member and a first other conductive member. The first structure overlaps the first element section in the second direction.

### CROSS-REFERENCE TO RELATED APPLICATIONS

This application is based upon and claims the benefit of priority from Japanese Patent Application No. 2024-117728, filed on Jul. 23, 2024; the entire contents of which are incorporated herein by reference.

### FIELD

Embodiments described herein relate generally to a sensor.

### BACKGROUND

For example, there is a sensor using a MEMS (Micro Electro Mechanical Systems) element, etc. It is desirable to improve the characteristics of the sensor.

### BRIEF DESCRIPTION OF THE DRAWINGS

FIG. 1 is a schematic plan view illustrating a sensor according to a first embodiment;

FIGS. 2A to 2C are schematic cross-sectional views illustrating the sensor according to the first embodiment;

FIGS. 3A and 3B are schematic cross-sectional views illustrating the sensor according to the first embodiment;

FIG. 4 is a schematic plan view illustrating a part of the sensor according to the first embodiment;

FIG. 5 is a schematic plan view illustrating the sensor according to the first embodiment;

FIG. 6 is a schematic plan view illustrating the sensor according to the first embodiment;

FIG. 7A to 7C are schematic cross-sectional views illustrating a sensor according to the first embodiment;

FIG. 8 is a schematic plan view illustrating a sensor according to a second embodiment;

FIGS. 9A to 9D are schematic cross-sectional views illustrating a sensor according to the second embodiment;

FIG. 10 is a schematic cross-sectional view illustrating a sensor according to a third embodiment;

FIG. 11 is a schematic cross-sectional view illustrating a sensor according to the third embodiment; and

FIG. 12 is a schematic plan view illustrating a sensor according to a fourth embodiment.

### DETAILED DESCRIPTION

According to one embodiment, a sensor includes a base, a first structure fixed to the base, and a first detection section. A second direction from the first structure to the first detection section crosses a first direction from the base to the first detection section. The first detection section includes a first element portion including a first conductive member and a first other conductive member. The first structure overlaps the first element section in the second direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

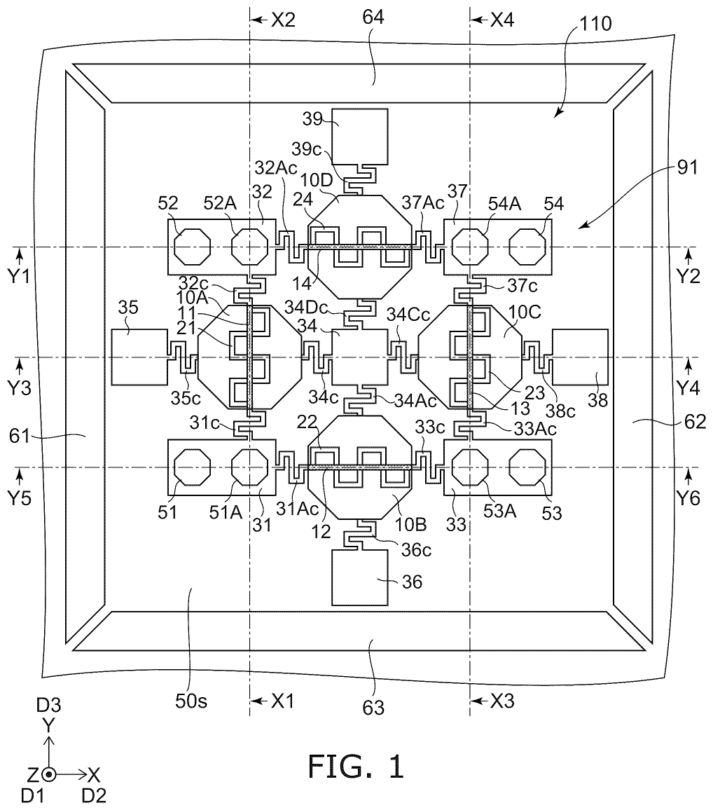

FIG. 1 is a schematic plan view illustrating a sensor according to a first embodiment.

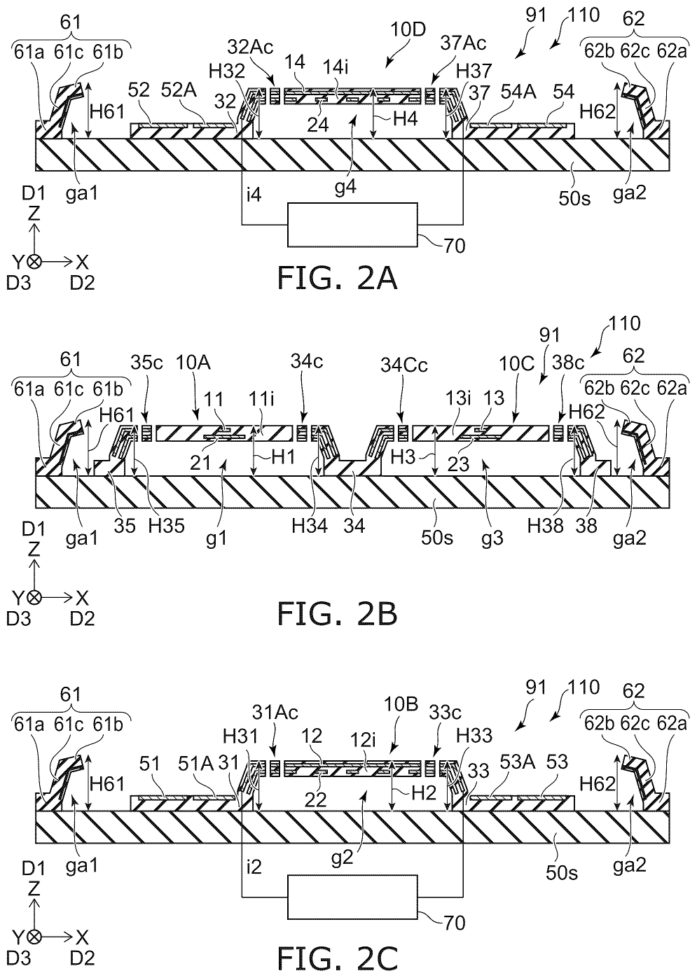

FIGS. 2A to 2C are schematic cross-sectional views illustrating the sensor according to the first embodiment.

FIG. 2A is a cross-sectional view taken along the line Y1-Y2 in FIG. 1. FIG. 2B is a cross-sectional view taken along the line Y3-Y4 in FIG. 1. FIG. 2C is a cross-sectional view taken along the line Y5-Y6 in FIG. 1.

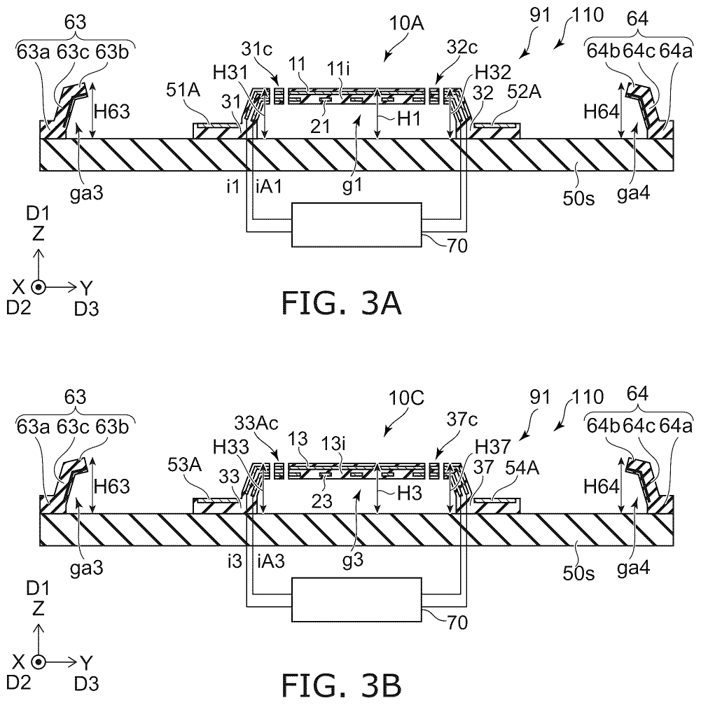

FIGS. 3A and 3B are schematic cross-sectional views illustrating the sensor according to the first embodiment.

FIG. 3A is a cross-sectional view taken along the line X1-X2 in FIG. 1. FIG. 3B is a cross-sectional view taken along the line X3-X4 in FIG. 1.

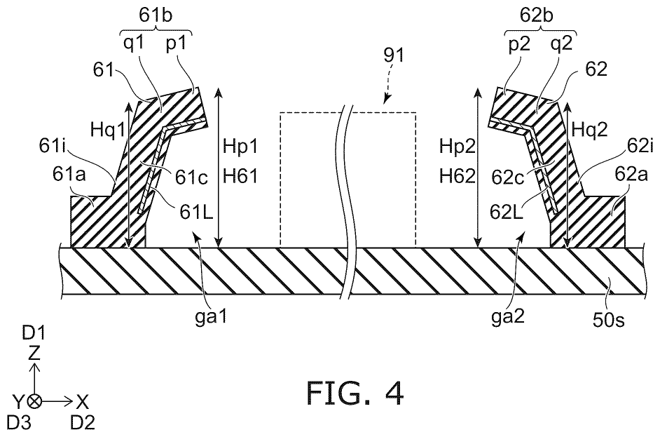

FIG. 4 is a schematic plan view illustrating a part of the sensor according to the first embodiment.

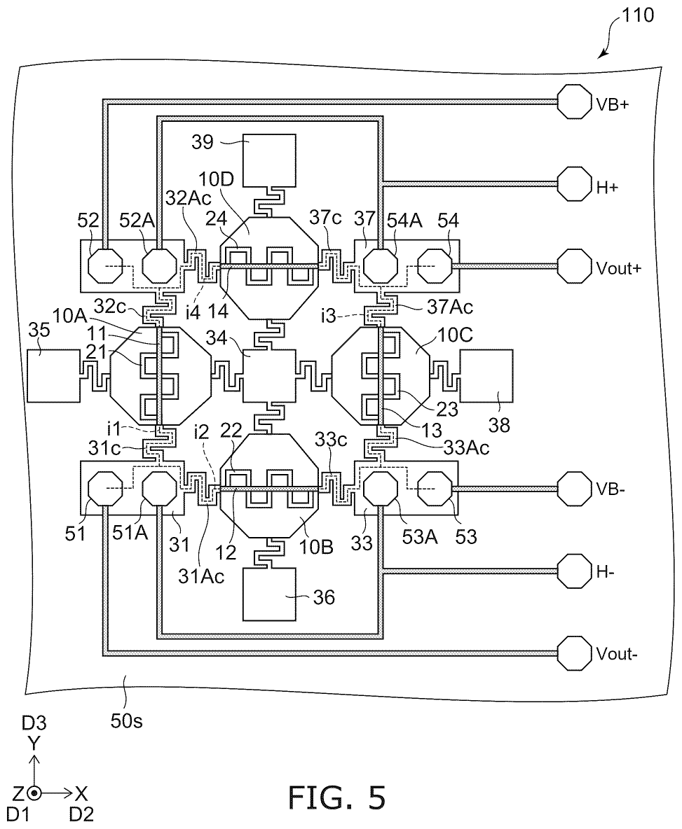

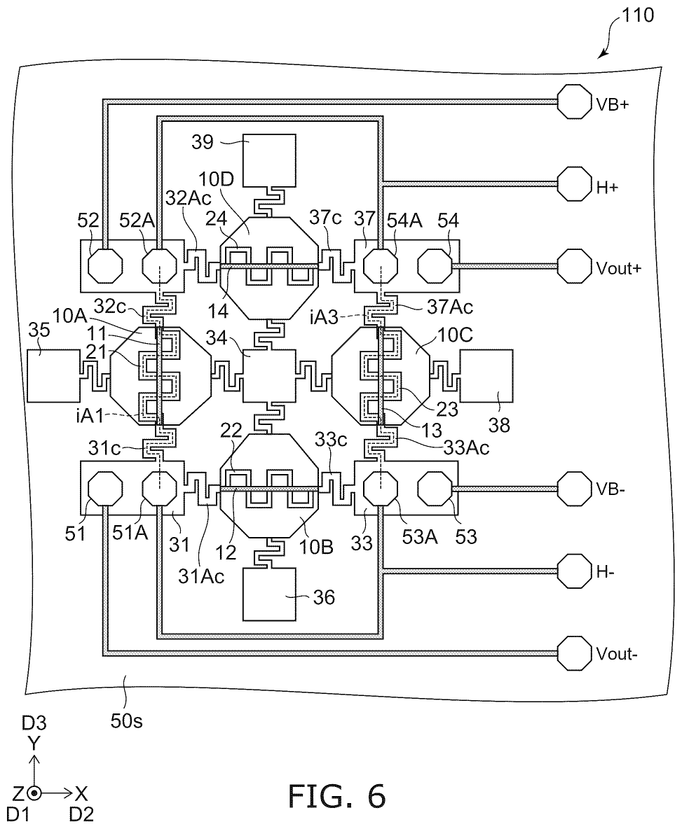

FIGS. 5 and 6 are schematic plan views illustrating the sensor according to the first embodiment.

The sensor 110 according to the embodiment includes a base 50s, a first structure 61, and a first detection section 91. The first structure 61 is fixed to the base 50s. A second direction D2 from the first structure 61 to the first detection section 91 crosses a first direction D1 from the base 50s to the first detection section 91.

The first direction D1 is the Z-axis direction. One direction perpendicular to the Z-axis direction is the X-axis direction. The direction perpendicular to the Z-axis and X-axis directions is the Y-axis direction. The second direction D2 is, for example, the X-axis direction.

The first detection section 91 includes a first element portion 10A.v The first element portion 10A includes a first conductive member 11 and a first other conductive member 21.

As shown in FIG. 2B, the first structure 61 overlaps the first element portion 10A in the second direction D2.

As shown in FIG. 3A, for example, a first other current iA1 is supplied to the first other conductive member 21. At this time, a state of the detection object around the first element portion 10A is detected based on a value corresponding to a change in the first electrical resistance of the first conductive member 11. The first other current iA1 increases the temperature of the first element portion 10A. Thereby, the first electrical resistance R1 of the first conductive member 11 is changed. The temperature of the first element portion 10A changes depending on the state of the detection object. This is due to, for example, changes in heat dissipation depending on the state of the detection object.

The detection target is, for example, a gas. The detection target is, for example, hydrogen. The state of the detection target is, for example, the concentration of the detection target (for example, the concentration of hydrogen). When the first other current iA1 is supplied, the temperature of the first element portion 10A is affected by the flow velocity of the detection target. The heat dissipation property changes with the change in the flow velocity.

In the embodiment, the first structure 61 above-mentioned is provided. The first structure 61 overlaps the first element portion 10A in the second direction D2. The first structure 61 functions as a wall that reduces the flow of the detection target. The first structure 61 appropriately controls the direction of the flow of the detection target. The flow of the detection target passes, for example, above the first element portion 10A and at a position away from the first element portion 10A. The effect of the flow velocity can be suppressed. For example, the concentration of the detection target can be detected more accurately. A sensor with improved characteristics can be provided.

As shown in FIG. 2B, the first structure 61 has a first structure height H61 relative to the base 50s. The first structure height H61 is a length along the first direction D1. The first element portion 10A has a first element portion height H1 relative to the base 50s. In the embodiment, the first structure height H61 is higher than the first element portion height H1. The effect of the flow velocity of the detection target can be more effectively suppressed.

In this example, the first element portion 10A is supported by a fixed portion (such as a first fixed portion 31). The fixed portion (such as the first fixed portion 31) is fixed to the base 50s. The fixed portion (such as the first fixed portion 31) supports the first element portion 10A. A first gap g1 is provided between the base 50s and the first element portion 10A. For example, the temperature of the first element portion 10A changes in response to changes in the gas thermal conductivity of the first gap g1. Highly accurate detection is possible.

In this example, the first element portion 10A is supported by a plurality of fixed portions (first fixed portion 31, second fixed portion 32, fourth fixed portion 34, and fifth fixed portion 35). Thus, the first detection section 91 may include a plurality of fixed portions (first fixed portion 31, second fixed portion 32, fourth fixed portion 34, and fifth fixed portion 35). As shown in FIG. 2B, the fixed portion (fifth fixed portion 35 in FIG. 2B) supporting the first element portion 10A has a fixed portion height (a fifth fixed portion height H35) relative to the base 50s. The first structure height H61 of the first structure 61 relative to the base 50s may be higher than the fixed portion height (fifth fixed portion height H35). The effect of the flow velocity of the detection target can be more effectively suppressed.

As shown in FIG. 4, the first structure 61 includes a first structure fixed portion 61a, a first structure protruding portion 61b, and a first structure connecting portion 61c. The first structure fixed portion 61a is fixed to the base 50s. The first structure connecting portion 61c is provided between the first structure fixed portion 61a and the first structure protruding portion 61b. The first structure connecting portion 61c connects the first structure protruding portion 61b to the first structure fixed portion 61a.

In the first direction D1, a first structure gap ga1 exists between the base 50s and the first structure protruding portion 61b. A position of the first structure protruding portion 61b in the second direction D2 is between a position of the first structure fixed portion 61a in the second direction D2 and a position of the first detection section 91 in the second direction D2.

By providing the first structure protruding portion 61b located above the first structure gap ga1, the flow of the detection target is more effectively controlled.

As shown in FIG. 4, the first structure protruding portion 61b includes a first end portion p1 and a first intermediate portion q1. The first intermediate portion q1 is between the first structure connecting portion 61c and the first end portion p1. A first end portion height Hp1 of the first end portion p1 relative to the base 50s is higher than a first intermediate portion height Hq1 of the first intermediate portion q1 relative to the base 50s. The first structure protruding portion 61b is inclined with respect to the Z-axis direction. By such a first structure protruding portion 61b, the flow of the detection target is more effectively controlled. The concentration of the detection target can be detected with higher accuracy. The first end portion height Hp1 may correspond to the first structure height H61.

As shown in FIG. 4, the first structure 61 includes a first insulating layer 61i and a first layer 61L. The first layer 61L overlaps the first insulating layer 61i. The material of the first layer 61L is different from the material of the first insulating layer 61i. Stress is generated by the first insulating layer 61i and the first layer 61L, which are made of different materials. The stress may result in the inclination of the first structure protruding portion 61b.

In one example, the first layer 61L may include the same material as the material of the first other conductive member 21. The order of the first insulating layer 61i and the first layer 61L is arbitrary. For example, the first layer 61L may be provided on the first insulating layer 61i.

For example, the first layer 61L may include compressive strain or tensile strain. The inclination of the first structure protruding portion 61b is efficiently obtained.

As shown in FIG. 1, the sensor 110 may further include a second structure 62. The second structure 62 is fixed to the base 50s. The first detection section 91 is between the first structure 61 and the second structure 62 in the second direction D2. As shown in FIG. 4, the second structure 62 overlaps the first detection section 91 in the second direction D2.

As shown in FIG. 2B, the second structure 62 has a second structure height H62 relative to the base 50s. The first element portion 10A has a first element portion height H1 relative to the base 50s. The second structure height H62 is higher than the first element portion height H1.

As already explained, the first detection section 91 includes a fixed portion (such as the fourth fixed portion 34 in the example of FIG. 4). The fixed portion (such as the fourth fixed portion 34 in the example of FIG. 4) is fixed to the base 50s and supports the first element portion 10A. The fixed portion has a fixed portion height (for example, the fourth fixed portion height H34) relative to the base 50s. The second structure 62 has the second structure height H62 relative to the base 50s. For example, the second structure height H62 is higher than the fixed portion height (for example, the fourth fixed portion height H34). For example, the flow of the detection target can be effectively controlled. The effects of flow velocity can be suppressed.

As shown in FIG. 4, the second structure 62 may include a second structure fixed portion 62a, a second structure protruding portion 62b, and a second structure connecting portion 62c. The second structure fixed portion 62a is fixed to the base 50s. The second structure connecting portion 62c is provided between the second structure fixed portion 62a and the second structure protruding portion 62b. The second structure connecting portion 62c connects the second structure protruding portion 62b to the second structure fixed portion 62a.

In the first direction D1, a second structure gap ga2 exists between the base 50s and the second structure protruding portion 62b. For example, a position of the second structure protruding portion 62b in the second direction D2 is between the position of the first detection section 91 in the second direction D2 and the position of the second structure fixed portion 62a in the second direction D2.

By providing the second structure protruding portion 62b located above the second structure gap ga2, the flow of the detection target is more effectively controlled.

The second structure protruding portion 62b includes a second end portion p2 and a second intermediate portion q2. The second intermediate portion q2 is between the second structure connecting portion 62c and the second end portion p2. A second end portion height Hp2 of the second end portion p2 relative to the base 50s may be higher than a second intermediate portion height Hq2 of the second intermediate portion q2 relative to the base 50s. The second structure protruding portion 62b is inclined with respect to the Z-axis direction. By such a second structure protruding portion 62b, the flow of the detection target is more effectively controlled. The concentration of the detection target can be detected with higher accuracy. The second end portion height Hp2 may correspond to the second structure height H62. As shown in FIG. 4, the second structure 62 includes a second insulating layer 62i and a second layer 62L. The second layer 62L overlaps the second insulating layer 62i. The material of the second layer 62L is different from the material of the second insulating layer 62i. The second insulating layer 62i and the second layer 62L, which are made of different materials, generate stress. The stress may result in the inclination of the second structure protruding portion 62b.

As shown in FIG. 1, the sensor 110 may further include a third structure 63 fixed to the base 50s, and a fourth structure 64 fixed to the base 50s. The first detection section 91 is between the third structure 63 and the fourth structure 64 in a third direction D3. The third direction D3 crosses a plane including the first direction D1 and the second direction D2. The third direction D3 may be, for example, the Y-axis direction.

For example, at least one of the third structure 63 or the fourth structure 64 overlaps the first detection section 91 in the third direction D3. The third structure 63 and the fourth structure 64 can effectively control the flow of the detection target.

The first structure 61, the second structure 62, the third structure 63, and the fourth structure 64 may be formed, for example, from a layer that will become at least a part of the first detection section 91. The structures can be obtained efficiently.

As shown in FIG. 3A, for example, the third structure 63 includes a third structure fixed portion 63a, a third structure protruding portion 63b, and a third structure connecting portion 63c. The third structure fixed portion 63a is fixed to the base 50s. The third structure connecting portion 63c is provided between the third structure fixed portion 63a and the third structure protruding portion 63b. The third structure connecting portion 63c connects the third structure protruding portion 63b to the third structure fixed portion 63a.

In the first direction D1, a third structure gap ga3 exists between the base 50s and the third structure protruding portion 63b. A position of the third structure protruding portion 63b in the third direction D3 is between a position of the third structure fixed portion 63a in the third direction D3 and a position of the first detection section 91 in the third direction D3.

As shown in FIG. 3A, for example, the fourth structure 64 includes a fourth structure fixed portion 64a, a fourth structure protruding portion 64b, and a fourth structure connecting portion 64c. The fourth structure fixed portion 64a is fixed to the base 50s. The fourth structure connecting portion 64c is provided between the fourth structure fixed portion 64a and the fourth structure protruding portion 64b. The fourth structure connecting portion 64c connects the fourth structure protruding portion 64b to the fourth structure fixed portion 64a.

In the first direction D1, a fourth structure gap ga4 exists between the base 50s and the fourth structure protruding portion 64b. A position of the fourth structure protruding portion 64b in the third direction D3 is between a position of the fourth structure fixed portion 64a in the third direction D3 and a position of the first detection section 91 in the third direction D3.

The third structure 63 may have a third structure height H63 relative to the base 50s, which is higher than the first element portion height H1. The fourth structure 64 may have a fourth structure height H64 relative to the base 50s, which is higher than the first element portion height H1.

The third structure 63 has the third structure height H63 relative to the base 50s and may be higher than the fixed portion height (e.g., the fifth fixed portion height H35, etc.). The fourth structure 64 has the fourth structure height H64 relative to the base 50s and may be higher than the fixed portion height (e.g., the fifth fixed portion height H35, etc.). The effect of the flow velocity of the detection target can be more effectively suppressed.

In the embodiment, the first detection section 91 may include the base 50s, the first fixed portion 31, the second fixed portion 32, the third fixed portion 33, the fourth fixed portion 34, the first element portion 10A, and the second element portion 10B. The first detection section 91 may further include a first connecting portion 31c, a second connecting portion 32c, a first other connecting portion 31Ac, a third connecting portion 33c, a fourth connecting portion 34c, and a fourth other connecting portion 34Ac.

The first fixed portion 31 is fixed to the base 50s. The second fixed portion 32 is fixed to the base 50s. The third fixed portion 33 is fixed to the base 50s. The fourth fixed portion 34 is fixed to the base 50s. The fifth fixed portion 35 is fixed to the base 50s. The sixth fixed portion 36 is fixed to the base 50s.

The first element portion 10A includes the first conductive member 11 and the first other conductive member 21. The second element portion 10B includes a second conductive member 12. The second element portion 10B may further include a second other conductive member 22.

The first connecting portion 31c is supported by the first fixed portion 31 and supports the first element portion 10A. The second connecting portion 32c is supported by the second fixed portion 32 and supports the first element portion 10A. The first other connecting portion 31Ac is supported by the first fixed portion 31 and supports the second element portion 10B. The third connecting portion 33c is supported by the third fixed portion 33 and supports the second element portion 10B. The fourth connecting portion 34c is supported by the fourth fixed portion 34 and supports the first element portion 10A. The fourth other connecting portion 34Ac is supported by the fourth fixed portion 34 and supports the second element portion 10B.

The first connecting portion 31c and the second connecting portion 32c are configured to pass a first current i1 flowing through the first conductive member 11. The first connecting portion 31c is configured to pass the first other current iA1 flowing through the first other conductive member 21. In this example, the second connecting portion 32c is configured to pass the first other current iA1.

The first other connecting portion 31Ac is configured to pass a second current i2 flowing through the second conductive member 12. In this example, the third connecting portion 33c is configured to pass the second current i2.

A controller 70 may be provided in the sensor 110. The controller 70 may be included in the sensor 110. The controller 70 may be provided separately from the sensor 110. The controller 70 is configured to supply the above current. The controller 70 is configured to apply a voltage corresponding to the above current. For example, the controller 70 is configured to supply the first current i1 to the first conductive member 11. The controller 70 is configured to supply the first other current iA1 to the first other conductive member 21. The controller 70 is configured to supply the second current i2 to the second conductive member 12.

In the first detection section 91, the state of the detection object around the first element portion 10A and the second element portion 10B is detected by a value corresponding to the difference between the first electrical resistance of the first conductive member 11 when the first other current iA1 flows through the first other conductive member 21, and the second electrical resistance of the second conductive member 12.

For example, by the first other current iA1 flowing through the first other conductive member 21, the temperature of the first element portion 10A rises. Thereby, the first electrical resistance R1 of the first conductive member 11 changes. The temperature of the first element portion 10A changes depending on the state of the detection target. This is thought to be due, for example, to changes in heat dissipation properties depending on the state of the detection target. On the other hand, the temperature of the second element portion 10B does not substantially change. For example, the second electrical resistance R2 of the second conductive member 12 is not substantially affected by the detection target.

For example, the first element portion 10A is a sensor element. The second element portion 10B is, for example, a reference element. By detecting the difference between the first electrical resistance R1 and the second electrical resistance R2, the state of the detection target can be detected with higher accuracy. The first detection section 91 is, for example, a resistance change type sensor. The controller 70 may be configured to detect a signal (such as a voltage) obtained from the element portion. The controller 70 may be configured to detect a value (signal) corresponding to the electrical resistance.

In the embodiment, the first element portion 10A is supported by the first connecting portion 31c, the second connecting portion 32c, and the fourth connecting portion 34c. As described above, the first current i1 flowing through the first conductive member 11 flows through the first connecting portion 31c and the second connecting portion 32c. The first other current iA1 flowing through the first other conductive member 21 flows through the first connecting portion 31c and the second connecting portion 32c. The first element portion 10A is supported by the fourth connecting portion 34c in addition to the two connecting portions that form the current path. Thereby, the first element portion 10A can be supported more stably.

In the embodiment, the second element portion 10B is supported by the first other connecting portion 31Ac, the third connecting portion 33c, and the fourth other connecting portion 34Ac. As described above, the second current i2 flowing through the second conductive member 12 flows through the first other connecting portion 31Ac and the third connecting portion 33c. The second element portion 10B is supported by the fourth other connecting portion 34Ac in addition to the two connections that form the current path. Thereby, the second element portion 10B can be supported more stably.

In the embodiment, the first element portion 10A and the second element portion 10B are stably supported. The characteristics of the first element portion 10A and the second element portion 10B are stable. The signals obtained from the first element portion 10A and the second element portion 10B are stable. Stable, highly accurate detection results are obtained. According to the embodiment, it is possible to provide a sensor whose characteristics can be improved.

The first current i1, the first other current iA1, and the second current i2 do not pass through the fourth connecting portion 34c and the fourth other connecting portion 34Ac.

The first gap g1 is provided between the base 50s and the first element portion 10A. A second gap g2 is provided between the base 50s and the second element portion 10B. The first element portion 10A and the second element portion 10B have a MEMS structure.

The second direction D2 from the first fixed portion 31 to the third fixed portion 33 crosses the first direction D1. The third direction D3 from the first fixed portion 31 to the second fixed portion 32 crosses a plane including the first direction D1 and the second direction D2.

The first detection section 91 may further include the fifth fixed portion 35, the sixth fixed portion 36, a fifth connecting portion 35c, and a sixth connecting portion 36c. The fifth fixed portion 35 is fixed to the base 50s. The sixth fixed portion 36 is fixed to the base 50s. The fifth connecting portion 35c is supported by the fifth fixed portion 35 and supports the first element portion 10A. The sixth connecting portion 36c is supported by the sixth fixed portion 36 and supports the second element portion 10B.

In this example, a direction from the fifth fixed portion 35 to the fourth fixed portion 34 is along the second direction D2. A direction from the sixth fixed portion 36 to the fourth fixed portion 34 is along the third direction D3. For example, at least a part of the first element portion 10A is between the fifth fixed portion 35 and the fourth fixed portion 34 in the second direction D2. For example, at least a part of the second element portion 10B is between the sixth fixed portion 36 and the fourth fixed portion 34 in the third direction D3.

The first current i1, the first other current iA1, and the second current i2 do not pass through the fourth connecting portion 34c, the fourth other connecting portion 34Ac, the fifth connecting portion 35c, and the sixth connecting portion 36c.

The first element portion 10A is supported by two connecting portions through which current passes, and two connecting portions through which current does not pass. By being supported by four connecting portions, the first element portion 10A is supported more stably. The second element portion 10B is supported by two connecting portions through which current passes, and two connecting portions through which current does not pass. By being supported by four connecting portions, the second element portion 10B is supported more stably. The signals obtained from these element portions become more stable. The characteristics are further improved.

In the embodiment, the fourth fixed portion 34 supports the fourth connecting portion 34c and the fourth other connecting portion 34Ac. For example, the fourth fixed portion 34 is shared by the first element portion 10A and the second element portion 10B. Thereby, the size of the first detection section 91 can be reduced. For example, a small “footprint” can be obtained. For example, the distance between the first element portion 10A and the second element portion 10B can be shortened. For example, the temperature difference between these elements can be reduced. The difference in characteristics can be reduced.

The second element portion 10B may further include the second other conductive member 22. The second other conductive member 22 may not be supplied with current.

The first element portion 10A may further include a first insulating member 11i. At least a part of the first insulating member 11i is provided between the first conductive member 11 and the first other conductive member 21. The first element portion 10A is, for example, membrane-shaped.

The second element portion 10B may further include a second insulating member 12i. At least a part of the second insulating member 12i is provided around the second conductive member 12. At least a part of the second insulating member 12i may be provided between the second conductive member 12 and the second other conductive member 22. The second element portion 10B is, for example, membrane-shaped.

The sensor 110 may further include a first electrode 51, a first other electrode 51A, a second electrode 52, a second other electrode 52A, and a third electrode 53. The first electrode 51 is connected to a part of the first conductive member 11 via the first connecting portion 31c. The first other electrode 51A is connected to a part of the first other conductive member 21 via the first connecting portion 31c. The second electrode 52 is connected to another part of the first conductive member 11 via the second connecting portion 32c. The second other electrode 52A is connected to another part of the first other conductive member 21 via the second connecting portion 32c.

For example, the third electrode 53 is connected to a part of the second conductive member 12 via the third connecting portion 33c. The first electrode 51 is connected to another part of the second conductive member 12 via the first other connecting portion 31Ac. The above-mentioned current is supplied via these electrodes. The first detection section 91 may further include a third other electrode 53A. The third other electrode 53A may be used when supplying a current to the second other conductive member 22, for example.

In this example, the first detection section 91 further includes a seventh fixed portion 37, a third element portion 10C, a fourth element portion 10D, a third other connecting portion 33Ac, a seventh connecting portion 37c, a fourth opposing connecting portion 34Cc, a second other connecting portion 32Ac, a seventh other connecting portion 37Ac, and a fourth opposing other connecting portion 34Dc.

The seventh fixed portion 37 is fixed to the base 50s. The third element portion 10C includes a third conductive member 13 and a third other conductive member 23. The fourth element portion 10D includes a fourth conductive member 14. The fourth element portion 10D may further include a fourth other conductive member 24.

The third other connecting portion 33Ac is supported by the third fixed portion 33 and supports the third element portion 10C. The seventh connecting portion 37c is supported by the seventh fixed portion 37 and supports the third element portion 10C. The fourth opposing connecting portion 34Cc is supported by the fourth fixed portion 34 and supports the third element portion 10C.

The second other connecting portion 32Ac is supported by the second fixed portion 32 and supports the fourth element portion 10D. The seventh other connecting portion 37Ac is supported by the seventh fixed portion 37 and supports the fourth element portion 10D. The fourth opposing other connecting portion 34Dc is supported by the fourth fixed portion 34 and supports the fourth element portion 10D.

The third other connecting portion 33Ac and the seventh connecting portion 37c are configured to pass a third current i3 flowing through the third conductive member 13. The third other connecting portion 33Ac and the seventh connecting portion 37c are configured to pass a third other current iA3 flowing through the third other conductive member 23. The second other connecting portion 32Ac and the seventh other connecting portion 37Ac are configured to pass a fourth current i4 flowing through the fourth conductive member 14.

These currents may be supplied by the controller 70.

Voltages corresponding to these currents may be supplied by the controller 70.

The third element portion 10C is supported by the fourth opposing connecting portion 34Cc in addition to the two connecting portions that form the current path. Thereby, the third element portion 10C can be supported more stably. The fourth element portion 10D is supported by the fourth opposing other connecting portion 34Dc in addition to the two connecting portions that form the current path. Thereby, the fourth element portion 10D can be supported more stably. The characteristics are further improved.

The first detection section 91 may further include an eighth fixed portion 38, a ninth fixed portion 39, an eighth connecting portion 38c, and a ninth connecting portion 39c. The eighth fixed portion 38 is fixed to the base 50s. The ninth fixed portion 39 is fixed to the base 50s. The eighth connecting portion 38c is supported by the eighth fixed portion 38 and supports the third element portion 10C. The ninth connecting portion 39c is supported by the ninth fixed portion 39 and supports the fourth element portion 10D.

The current flowing through the third element portion 10C may not flow through the eighth connecting portion 38c. The third element portion 10C is further supported by the eighth connecting portion 38c, through which current dos not flow. The third element portion 10C becomes further stable.

The current flowing through the fourth element portion 10D may not flow through the ninth connecting portion 39c. The fourth element portion 10D is further supported by the ninth connecting portion 39c, through which current does not flow. The fourth element portion 10D becomes further stable.

In the second direction D2, the fourth fixed portion 34 is provided between the fifth fixed portion 35 and the eighth fixed portion 38. In the second direction D2, the first element portion 10A is provided between the fifth fixed portion 35 and the fourth fixed portion 34. In the second direction D2, the third element portion 10C is provided between the fourth fixed portion 34 and the eighth fixed portion 38. In the second direction D2, the second element portion 10B is provided between the first fixed portion 31 and the third fixed portion 33. In the second direction D2, the fourth element portion 10D is provided between the second fixed portion 32 and the seventh fixed portion 37.

In the third direction D3, the fourth fixed portion 34 is provided between the sixth fixed portion 36 and the ninth fixed portion 39. In the third direction D3, the second element portion 10B is provided between the sixth fixed portion 36 and the fourth fixed portion 34. In the third direction D3, the fourth element portion 10D is provided between the fourth fixed portion 34 and the ninth fixed portion 39. In the third direction D3, the first element portion 10A is provided between the first fixed portion 31 and the second fixed portion 32. In the third direction D3, the third element portion 10C is provided between the third fixed portion 33 and the seventh fixed portion 37.

By this configuration, the four element portions can be efficiently arranged in a small footprint area.

The first detection section 91 may further include a third electrode 53, a third other electrode 53A, a fourth electrode 54, and a fourth other electrode 54A. The third electrode 53 is connected to a part of the third conductive member 13 via a third other connecting portion 33Ac. The third other electrode 53A is connected to a part of the third other conductive member 23 via a third other connecting portion 33Ac.

The fourth electrode 54 is connected to another part of the third conductive member 13 via the seventh connecting portion 37c. The fourth other electrode 54A is connected to another part of the third other conductive member 23 via the seventh connecting portion 37c. The above-mentioned current is supplied via these electrodes.

For example, the state of the detection object around the third element portion 10C and the fourth element portion 10D is detected by a value corresponding to a difference between a third electrical resistance R3 of the third conductive member 13 and a fourth electrical resistance R4 of the fourth conductive member 14 when the third other current iA3 flows through the third other conductive member 23. For example, by the third other current iA3 flowing through the third other conductive member 23, the temperature of the third element portion 10C rises. Thereby, the third electrical resistance R3 of the third conductive member 13 changes. The temperature of the third element portion 10C changes depending on the state of the detection object. This is thought to be due to, for example, changes in heat dissipation depending on the state of the detection object. On the other hand, for example, the temperature of the fourth element portion 10D does not substantially change. For example, the fourth electrical resistance R4 of the fourth conductive member 14 is not substantially affected by the detection object.

For example, the third element portion 10C is a sensor element. The fourth element portion 10D is, for example, a reference element. By detecting the difference between the third electrical resistance R3 and the fourth electrical resistance R4, the state of the detection target can be detected with higher accuracy.

The fourth fixed portion 34 is shared by the first element portion 10A, the second element portion 10B, the third element portion 10C, and the fourth element portion 10D. Thereby, the size of the first detection section 91 can be reduced.

A third gap g3 is provided between the base 50s and the third element portion 10C. A fourth gap g4 is provided between the base 50s and the fourth element portion 10D. The third element portion 10C and the fourth element portion 10D have a MEMS structure.

The fourth element portion 10D may further include a fourth other conductive member 24. The fourth other conductive member 24 may not be supplied with current.

The third element portion 10C may further include a third insulating member 13i. At least a part of the third insulating member 13i is provided between the third conductive member 13 and the third other conductive member 23. The third element portion 10C is, for example, membrane-shaped. The fourth element portion 10D may further include a fourth insulating member 14i. At least a part of the fourth insulating member 14i is provided around the fourth conductive member 14. At least a part of the fourth insulating member 14i may be provided between the fourth conductive member 14 and the fourth other conductive member 24. The fourth element portion 10D is, for example, membrane-shaped.

The controller 70 is configured to supply the third current 13 to the third conductive member 13. The controller 70 is configured to supply the third other current iA3 to the third other conductive member 23. The controller 70 is configured to supply the fourth current i4 to the fourth conductive member 14.

At least one of the first conductive member 11, the first other conductive member 21, or the second conductive member 12 may include at least one selected from the group consisting of Ti, Al, TiN, Pt, and Au. At least one of the third conductive member 13, the third other conductive member 23, or the fourth conductive member 14 may include at least one selected from the group consisting of Ti, Al, TiN, Pt, and Au.

At least one of the first conductive member 11, the first other conductive member 21, or the second conductive member 12 may have a meander structure. At least one of the third conductive member 13, the third other conductive member 23, or the fourth conductive member 14 may have a meander structure. In FIG. 1, these conductive members are depicted in a simplified manner to make the figure easier to see.

In the embodiment, the detection target may be detected by a first detection result based on signals obtained from the first element portion 10A and the second element portion 10B. In the embodiment, the detection target may be detected by a second detection result based on signals obtained from the third element portion 10C and the fourth element portion 10D. The detection target may be detected based on the first detection result and the second detection result. In the embodiment, detection may be performed by applying a bridge circuit. The detection result with higher accuracy is obtained.

As shown in FIG. 5, for example, a voltage VB+ is applied to the second electrode 52. A voltage VB− is applied to the third electrode 53. In this example, the second electrode 52 is electrically connected to another part of the first conductive member 11 via the second connecting portion 32c. A part of the first conductive member 11 is electrically connected to a part of the second conductive member 12 via the first connecting portion 31c and the first other connecting portion 31Ac. Another part of the second conductive member 12 is electrically connected to the third electrode 53 via the third connecting portion 33c.

The first conductive member 11 and the second conductive member 12 are electrically connected in series. The voltages VB+ and VB− are applied to these conductive members. Currents based on these voltages flow through these conductive members. The first current i1 flows through the first conductive member 11. The second current i2 flows through the second conductive member 12. The first current i1 flowing through the first conductive member 11 flows through the second conductive member 12 as the second current i2. The second current i2 flowing through the second conductive member 12 flows through the first conductive member 11 as the first current i1. These currents correspond to currents for detecting the electrical resistance of these conductive members.

In this example, the second electrode 52 is electrically connected to a part of the fourth conductive member 14 via the second other connecting portion 32Ac. Another part of the fourth conductive member 14 is electrically connected to a part of the third conductive member 13 via the seventh connecting portion 37c and the seventh other connecting portion 37Ac. Another part of the third conductive member 13 is electrically connected to the third electrode 53 via the third other connecting portion 33Ac.

The fourth conductive member 14 and the third conductive member 13 are electrically connected in series. The voltages VB+ and VB− are applied to these conductive members. Currents based on these voltages flow through these conductive members. The third current i3 flows through the third conductive member 13. The fourth current i4 flows through the fourth conductive member 14. The third current i3 flowing through the third conductive member 13 flows through the fourth conductive member 14 as the fourth current i4. The fourth current i4 flowing through the fourth conductive member 14 flows through the third conductive member 13 as the third current i3. These currents correspond to the currents for detecting the electrical resistance of these conductive members.

A first circuit including a first conductive member 11 and a second conductive member 12 is electrically connected in parallel with a circuit including a third conductive member 13 and a fourth conductive member 14. This forms a bridge circuit.

The first electrode 51 is electrically connected to a part of the first conductive member 11 and a part of the second conductive member 12. An output Vout− of the bridge circuit is obtained from the first electrode 51. The fourth electrode 54 is electrically connected to a part of the third conductive member 13 and a part of the fourth conductive member 14. Another output Vout+ of the bridge circuit is obtained from the fourth electrode 54.

As shown in FIG. 5, the first other electrode 51A is electrically connected to a part of the first other conductive member 21. The second other electrode 52A is electrically connected to another part of the first other conductive member 21. The third other electrode 53A is electrically connected to a part of the third other conductive member 23. The fourth other electrode 54A is electrically connected to another part of the third other conductive member 23. A voltage H− is applied to the first other electrode 51A and the third other electrode 53A. A voltage H+ is applied to the second other electrode 52A and the fourth other electrode 54A. By these voltages, other currents flow through these other conductive members.

The first other current iA1 is supplied to the first other conductive member 21. The first element portion 10A is heated. The third other current iA3 is supplied to the third other conductive member 23. The third element portion 10C is heated. These currents correspond to the power for heating.

The first element portion 10A has the first element portion height H1 relative to the base 50s. The second element portion 10B has a second element portion height H2 relative to the base 50s. The third element portion 10C has a third element portion height H3 relative to the base 50s. The fourth element portion 10D has a fourth element portion height H4 relative to the base 50s.

Each of the first structure height H61, the second structure height H62, the third structure height H63, and the fourth structure height H64 may be higher than the element portion height described above.

The first fixed portion 31 has a first fixed portion height H31 relative to the base 50s. The second fixed portion 32 has a second fixed portion height H32 relative to the base 50s. The third fixed portion 33 has a third fixed portion height H33 relative to the base 50s. The fourth fixed portion 34 has a fourth fixed portion height H34 relative to the base 50s. The fifth fixed portion 35 has a fifth fixed portion height H35 relative to the base 50s. The sixth fixed portion 36 has a sixth fixed portion height H36 relative to the base 50s. The seventh fixed portion 37 has a seventh fixed portion height H37 relative to the base 50s. The eighth fixed portion 38 has an eighth fixed portion height H38 relative to the base 50s. The ninth fixed portion 39 has a ninth fixed portion height H39 relative to the base 50s.

Each of the first structure height H61, the second structure height H62, the third structure height H63, and the fourth structure height H64 may be higher than the fixed portion height described above.

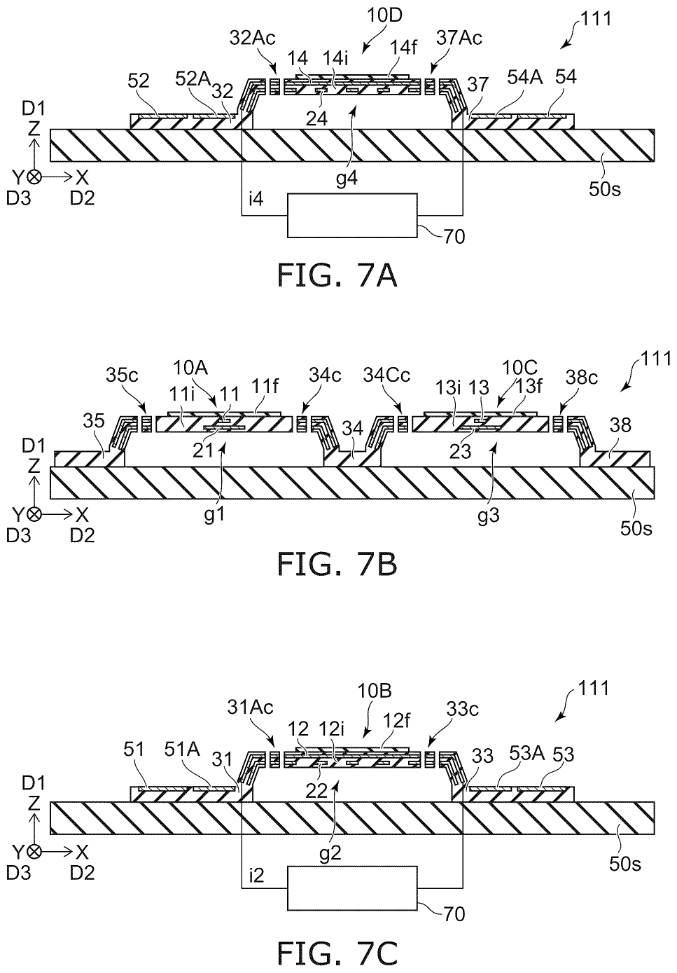

FIG. 7A to 7C are schematic cross-sectional views illustrating a sensor according to the first embodiment.

FIG. 7A is a cross-sectional view corresponding to the line Y1-Y2 in FIG. 1. FIG. 7B is a cross-sectional view corresponding to the line Y3-Y4 in FIG. 1. FIG. 7C is a cross-sectional view corresponding to the line Y5-Y6 in FIG. 1. In these figures, the above-mentioned structures are omitted. As shown in these figures, in a sensor 111 according to the embodiment, the first element portion 10A further includes a first film 11f. Except for this, the configuration of the sensor 111 may be the same as the configuration of the sensor 110.

In this example, the first conductive member 11 is provided between the base 50s and the first film 11f. The first film 11f includes at least one selected from the group consisting of Pt and Pd, for example. These materials function as, for example, a catalyst. Higher sensitivity is obtained.

The second element portion 10B may further include a second film 12f. In this example, the second conductive member 12 is provided between the base 50s and the second film 12f. The second film 12f includes, for example, at least one selected from the group consisting of Pt and Pd.

The third element portion 10C may further include a third film 13f. For example, the third conductive member 13 is provided between the base 50s and the third film 13f. The third film 13f includes, for example, at least one selected from the group consisting of Pt and Pd.

The fourth element portion 10D may further include a fourth film 14f. For example, the fourth conductive member 14 is provided between the base 50s and the fourth film 14f. The fourth film 14f includes, for example, at least one selected from the group consisting of Pt and Pd. The sensor 111 is, for example, a contact combustion type sensor.

The sensor according to the embodiment may include, for example, a thermal conduction type gas sensor. The sensor according to the embodiment may include, for example, a catalytic combustion type sensor. The sensor according to the embodiment may include, for example, an oxide semiconductor type sensor. The embodiment may be applied to any sensor in which the detecting portion is heated.

### Second Embodiment

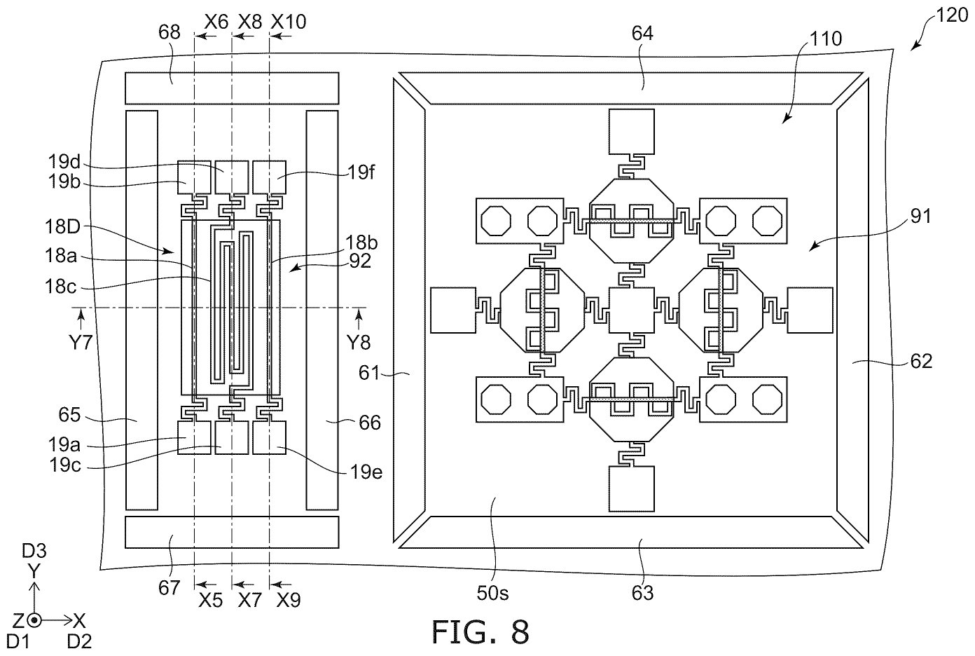

FIG. 8 is a schematic plan view illustrating a sensor according to a second embodiment.

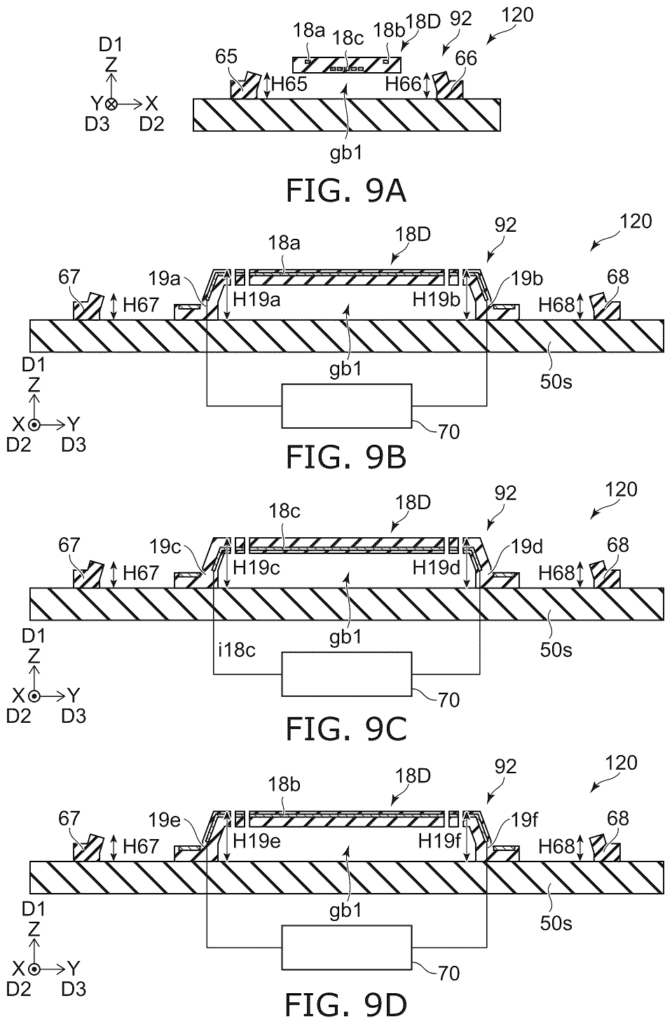

FIGS. 9A to 9D are schematic cross-sectional views illustrating a sensor according to the second embodiment.

FIG. 9A is a cross-sectional view taken along the line Y7-Y8 in FIG. 8. FIG. 9B is a cross-sectional view taken along the line X5-X6 in FIG. 8. FIG. 9C is a cross-sectional view taken along the line X7-X8 in FIG. 8. FIG. 9D is a cross-sectional view taken along the line X9-X10 in FIG. 8.

As shown in FIG. 9, a sensor 120 according to the embodiment further includes a second detection section 92 in addition to the first detection section 91. The configuration of the sensor 120 except for this may be the same as the configuration of the sensor 110, etc.

In the second direction D2, the first structure 61 is between the second detection section 92 and the first detection section 91. The second detection section 92 includes a second detection element portion 18D. The second detection element portion 18D includes a first resistance member 18a, a second resistance member 18b, and an intermediate conductive member 18c. The first structure 61 overlaps the second detection section 92 in the second direction D2. For example, the first structure 61 overlaps the second detection element portion 18D in the second direction D2.

A position of the intermediate conductive member 18c in the second direction D2 (intermediate conductive member position) is between a position of the first resistance member 18a in the second direction D2 (first resistance member position) and a position of the second resistance member 18b in the second direction D2 (second resistance member position).

In the second detection section 92, for example, an intermediate conductive member current i18c is supplied to the intermediate conductive member 18c. Thereby, the temperature of the second detection element portion 18D rises. On the other hand, the detection target passes around the intermediate conductive member 18c along the second direction D2. The first resistance member 18a is upstream of the flow of the detection target. The second resistance member 18b is downstream of the flow of the detection target. A difference in temperatures is generated between these resistance members depending on the flow of the detection target. The temperature difference can be detected by the electrical resistance of each of these resistance members. The temperature difference depends on the flow velocity of the detection target.

For example, when the intermediate conductive member current i18c is supplied to the intermediate conductive member 18c, a second signal corresponding to the flow velocity of the detection object passing around the second detection section 92 is detected from the difference between a first resistance member electrical resistance of the first resistance member 18a and a second resistance member electrical resistance of the second resistance member 18b. The second detection section 92 is, for example, a flow velocity sensor.

A first resistance member electrical resistance of the first resistance member 18a may be detected by the controller 70. The second resistance member electrical resistance of the second resistance member 18b may be detected by the controller 70. The difference between these electrical resistances may be detected by the controller 70.

The detection result of the first detection section 91 may be corrected by the detection result of the second detection section 92. The detection result of the second detection section 92 may be corrected by the detection result of the first detection section 91.

As already explained, a first signal corresponding to the concentration of the detection target around the first detection section 91 may be detected based on a value corresponding to the change in the first electrical resistance R1 of the first conductive member 11 when the first other current iA1 flows through the first other conductive member 21. The value corresponding to the change in the first electrical resistance R1 may include the difference between the first electrical resistance R1 and the second electrical resistance R2.

The controller 70 may be configured to perform, for example, at least one of a first operation or a second operation. The first operation includes correcting the first signal based on the second signal. The second operation includes correcting the second signal based on the first signal. A more accurate detection result can be obtained.

As shown in FIGS. 8 and 9A, the sensor 120 may further include a fifth structure 65. The fifth structure 65 is fixed to the base 50s. The second detection section 92 is between the fifth structure 65 and the first detection section 91 in the second direction D2. The second detection section 92 is between the fifth structure 65 and the first structure 61 in the second direction D2. For example, a fifth structure height H65 of the fifth structure 65 relative to the base 50s may be lower than the first structure height H61. The detection target can pass around the second detection section 92 while the effect on the flow of the detection target is suppressed. The flow velocity can be detected more accurately.

The sensor 120 may further include a sixth structure 66. The sixth structure 66 is fixed to the base 50s. The sixth structure 66 is between the second detection section 92 and the first structure 61 in the second direction D2. For example, a sixth structure height H66 of the sixth structure 66 relative to the base 50s may be lower than the first structure height H61.

The sensor 120 may further include a seventh structure 67 and an eighth structure 68. The seventh structure 67 and the eighth structure 68 are fixed to the base 50s. The second detection section 92 is between the seventh structure 67 and the eighth structure 68 in the third direction D3.

The second detection section 92 includes a plurality of fixed portions (fixed portion 19a, fixed portion 19b, fixed portion 19c, fixed portion 19d, fixed portion 19e, and fixed portion 19f). The second detection element portion 18D may be supported by these fixed portions. The direction from fixed portion 19a to fixed portion 19b is along the third direction D3. The direction from fixed portion 19c to fixed portion 19d is along the third direction D3. The direction from fixed portion 19e to fixed portion 19f is along the third direction D3. A connecting portion may be provided between each of these fixed portions and the second detection element portion 18D. The connecting portion may have a meandering structure.

A gap gb1 may be provided between the base 50s and the second detection element portion 18D.

The fixed portion 19a has a fixed portion height H19a relative to the base 50s. The fixed portion 19b has a fixed portion height H19b relative to the base 50s. The fixed portion 19c has a fixed portion height H19c relative to the base 50s. The fixed portion 19d has a fixed portion height H19d relative to the base 50s. The fixed portion 19e has a fixed portion height H19e relative to the base 50s. The fixed portion 19f has a fixed portion height H19f relative to the base 50s.

The seventh structure 67 has a seventh structure height H67 relative to the base 50s. The eighth structure 68 has an eighth structure height H68 relative to the base 50s. These structure heights may be lower than the fixed portion heights H19a to H19f.

### Third Embodiment

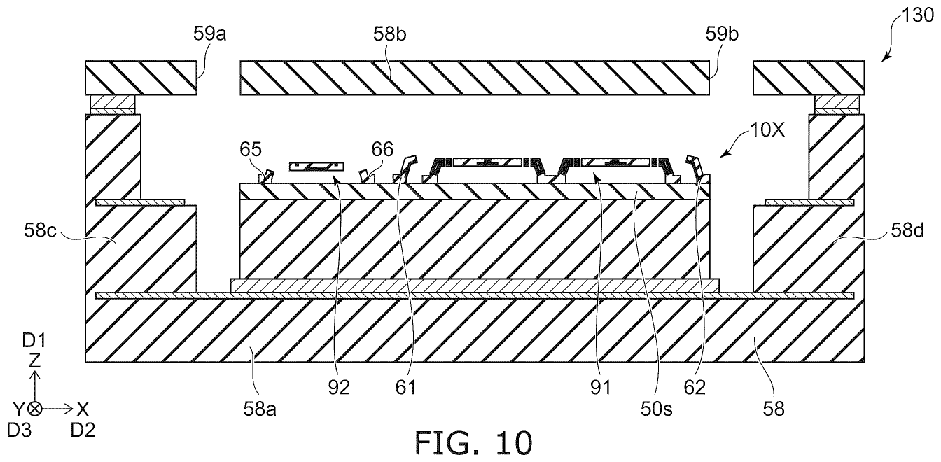

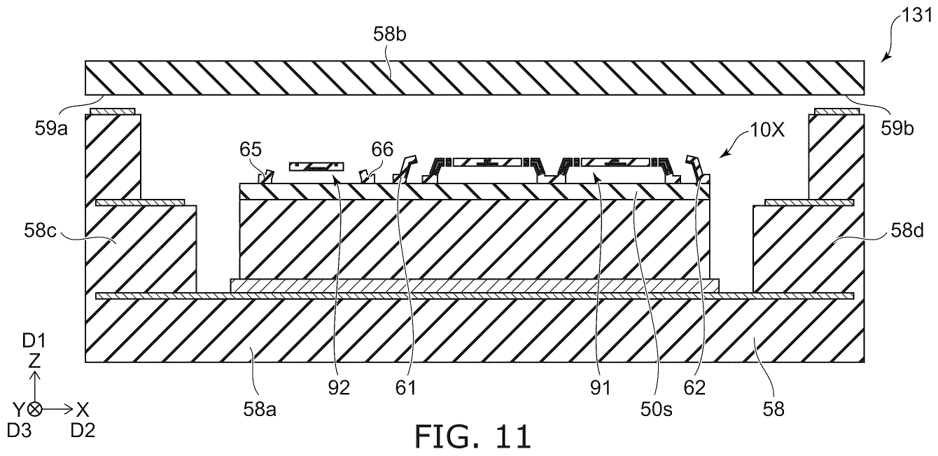

FIGS. 10 and 11 are schematic cross-sectional views illustrating a sensor according to a third embodiment.

As shown in FIG. 10, a sensor 130 according to the embodiment includes a housing 58. The configuration of sensor 130 except for this may be the same as the configuration of sensor 110, sensor 111, or sensor 120.

The housing 58 includes a first opening 59a and a second opening 59b. The detection device 10X including the first structure 61, the first detection section 91 and the second detection section 92 is placed in a space inside the housing 58. In this example, the housing 58 includes a first housing member 58a, a second housing member 58b, a third housing member 58c and a fourth housing member 58d. A direction from the first housing member 58a to the second housing member 58b is along the first direction D1. A direction from the third housing member 58c to the fourth housing member 58d is along the second direction D2.

In the example of the sensor 130 shown in FIG. 10, the first opening 59a and the second opening 59b are provided in the second housing member 58b.

A position of the detection device 10X in the second direction D2 is between a position of the first opening 59a in the second direction D2 and a position of the second opening 59b in the second direction D2. For example, the detection target (e.g., gas) is introduced into the housing 58 from the first opening 59a. The detection target passes through the space around the second detection section 92 and the first detection section 91, and is discharged from the second opening 59b. The flow of the detection target is effectively controlled by the first structure 61. In the sensor 131 shown in FIG. 1, the first opening 59a is provided in the third housing member 58c. Alternatively, the first opening 59a is provided between the third housing member 58c and the second housing member 58b. The second opening 59b is provided in the fourth housing member 58d. Alternatively, the second opening 59b is provided between the fourth housing member 58d and the second housing member 58b. In the sensor 131 as well, the flow of the detection target is effectively controlled by the first structure 61.

### Fourth Embodiment

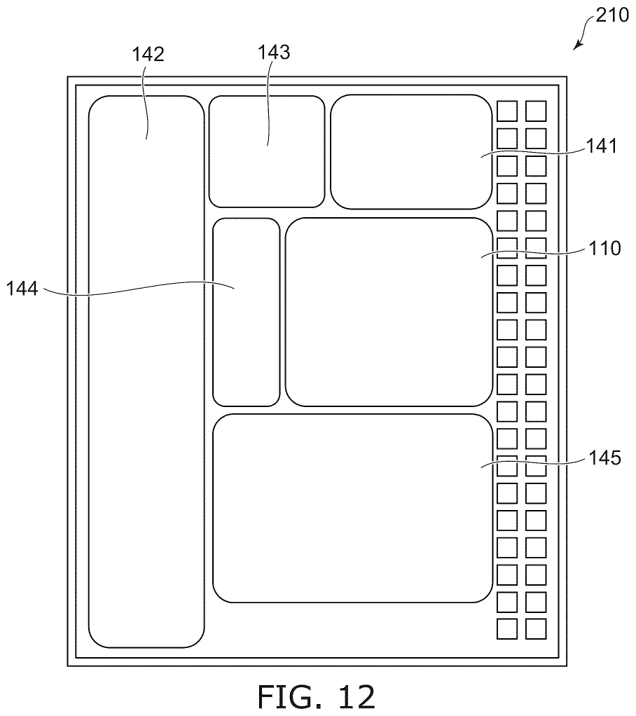

FIG. 12 is a schematic plan view illustrating a sensor according to a fourth embodiment.

As shown in FIG. 12, a sensor 210 according to the embodiment includes a sensor according to the first to third embodiments (e.g., sensor 110) and other sensors. The other sensors include at least one of a capacitive gas sensor 141 (e.g., a capacitive hydrogen sensor), a capacitive humidity sensor 142, an oxide semiconductor sensor 143, a gas flow sensor 144, and a catalytic combustion sensor 145. The sensor according to the first embodiment (e.g., sensor 110) includes, for example, a thermal conduction gas sensor. The sensor 210 is, for example, a sensor system. The gas flow sensor 144 may be the second detection section 92. The other sensors may include a temperature sensor, etc.

In the sensor 210, various types of sensors are provided. A highly accurate and convenient sensor can be provided. In the embodiment, the detection results of one sensor of a different type may be used to correct the detection results of two other sensors.

The embodiment may include the following Technical proposals:

### (Technical Proposal 1)

A sensor, comprising:
a base;
a first structure fixed to the base; and
a first detection section,
a second direction from the first structure to the first detection section crossing a first direction from the base to the first detection section,
the first detection section includes a first element portion including a first conductive member and a first other conductive member, and
the first structure overlapping the first element section in the second direction.

### (Technical Proposal 2)

The sensor according to Technical proposal 1, wherein
the first structure has a first structure height relative to the base,
the first element portion has a first element portion height relative to the base, and
the first structure height is higher than the first element portion height.

### (Technical Proposal 3)

The sensor according to Technical proposal 1, wherein
the first detection section further includes a fixed portion fixed to the base and supports the first element portion,
the fixed portion has a fixed portion height relative to the base,
the first structure has a first structure height relative to the base,
the first structure height is higher than the fixed portion height.

### (Technical Proposal 4)

The sensor according to any one of Technical proposals 1-3, wherein
the first structure includes:
   a first structure fixed portion fixed to the base;
   a first structure protruding portion, and
   a first structure connecting portion provided between the first structure fixed portion and the first structure protruding portion, the first structure connecting portion connecting the first structure protruding portion to the first structure fixed portion,
a first structure gap exists between the base and the first structure protruding portion in the first direction.

### (Technical Proposal 5)

The sensor according to Technical proposal 4, wherein
the first structure protruding portion includes:
   a first end portion, and
   a first intermediate portion between the first structure connecting portion and the first end portion,
a first end height of the first end portion relative to the base is higher than a first intermediate portion height of the first intermediate portion relative to the base.

### (Technical Proposal 6)

The sensor according to Technical proposal 4 or 5, wherein
a position of the first structure protruding portion in the second direction is between a position of the first structure fixed portion in the second direction and a position of the first detecting portion in the second direction.

### (Technical Proposal 7)

The sensor according to any one of Technical proposals 1-6, wherein
the first structure includes a first insulating layer and a first layer overlapping the first insulating layer.

### (Technical Proposal 8)

The sensor according to Technical proposal 1, further comprising:
a second structure fixed to the base,
the first detection section is between the first structure and the second structure in the second direction, and
the second structure overlaps the first element portion in the second direction.

### (Technical Proposal 9)

The sensor according to Technical proposal 8, wherein
the second structure has a second structure height relative to the base,
the first element portion has a first element portion height relative to the base, and
the second structure height is higher than the first element portion height.

### (Technical Proposal 10)

The sensor according to Technical proposal 8, wherein
the first detection section further includes a fixed portion fixed to the base and supports the first element portion, and
the fixed portion has a fixed portion height relative to the base,
the second structure has a second structure height relative to the base, and
the second structure height is higher than the fixed portion height.

### (Technical Proposal 11)

The sensor according to any one of Technical proposals 8-10, wherein
the second structure includes:
   a second structure fixed portion fixed to the base,
   a second structure protruding portion, and
   a second structure connecting portion provided between the second structure fixed portion and the second structure protruding portion, the second structure connecting portion connecting the second structure protruding portion to the second structure fixed portion, and
a second structure gap exists between the base and the second structure protruding portion in the first direction.

### (Technical Proposal 12)

The sensor according to Technical proposal 11, wherein
the second structure protruding portion includes
   a second end portion, and
   a second intermediate portion between the second structure connecting portion and the second end portion, and
a second end height of the second end portion relative to the base is higher than a second intermediate portion height of the second intermediate portion relative to the base.

### (Technical Proposal 13)

The sensor according to Technical proposal 11 or 12, wherein
a position of the second structure protruding portion in the second direction is between a position of the first detecting portion in the second direction and a position of the second structure fixed portion in the second direction.

### (Technical Proposal 14)

The sensor according to any one of Technical proposals 8-13, further comprising:
a third structure fixed to the base; and
a fourth structure fixed to the base,
the first detection section is between the third structure and the fourth structure in a third direction, and
the third direction crosses a plane including the first direction and the second direction.

### (Technical Proposal 15)

The sensor according to any one of Technical proposals 1-14, wherein
a state of a detection target around the first element portion is configured to be detected based on a value corresponding to a change in a first electrical resistance of the first conductive member when a first other current is supplied to the first other conductive member.

### (Technical Proposal 16)

The sensor according to Technical proposal 2 or 3, further comprising:
a second detection section,
in the second direction, the first structure is between the second detection section and the first detection section,
the second detection section includes a second detection element portion, the second detection element portion including a first resistance member, a second resistance member, and an intermediate conductive member,
the first structure overlaps the second detection element portion in the second direction, and
an intermediate conductive member position in the second direction is between a first resistance member position in the second direction of the first resistance member and a second resistance member position in the second direction of the second resistance member.

### (Technical Proposal 17)

The sensor according to Technical proposal 16, further comprising:
a fifth structure fixed to the base,
the second detection section is between the fifth structure and the first detection section in the second direction,
a fifth structure height of the fifth structure relative to the base is lower than the first structure height.

### (Technical Proposal 18)

The sensor according to Technical proposal 16 or 17, wherein
a second signal corresponding to a flow velocity of a detection object passing around the second detection section is configured to be detected based on a difference between a first resistance member electrical resistance of the first resistance member and a second resistance member electrical resistance of the second resistance member when an intermediate conductive member current is supplied to the intermediate conductive member.

### (Technical Proposal 19)

The sensor according to Technical proposal 18, further comprising:
a controller,
a first signal corresponding to a concentration of the detection target around the first detection section being configured to be detected based on a value according to a change in a first electrical resistance of the first conductive member when a first other current flows through the first other conductive member,
the controller being configured to perform at least one of a first operation or a second operation,
the first operation including correcting the first signal based on the second signal, and
the second operation including correcting the second signal based on the first signal.

### (Technical Proposal 20)

The sensor according to any one of Technical proposals 16-19, further comprising:
a housing including a first opening and a second opening,
a detection device including the first structure, the first detection section, and the second detection section being placed in a space inside the housing, and
a position of the detection device in the second direction being between a position of the first opening in the second direction and a position of the second opening in the second direction.

According to this embodiment, a sensor with improved characteristics can be provided.

In the specification, “electrically connected” includes a state in which plurality of conductors are physically in contact with each other and current flows between these plurality of conductors. “Electrically connected” includes a state in which a conductor is inserted between plurality of conductors and current flows between these plurality of conductors.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as bases, detection sections, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base;
a first structure fixed to the base; and
a first detection section,
a second direction from the first structure to the first detection section crossing a first direction from the base to the first detection section,
the first detection section includes a first element portion including a first conductive member and a first other conductive member, and
the first structure overlapping the first element section in the second direction.

2. The sensor according to claim 1, wherein
the first structure has a first structure height relative to the base,
the first element portion has a first element portion height relative to the base, and
the first structure height is higher than the first element portion height.

3. The sensor according to claim 1, wherein
the first detection section further includes a fixed portion fixed to the base and supports the first element portion,
the fixed portion has a fixed portion height relative to the base,
the first structure has a first structure height relative to the base,
the first structure height is higher than the fixed portion height.

4. The sensor according to claim 1, wherein
the first structure includes:
a first structure fixed portion fixed to the base;
a first structure protruding portion, and
a first structure connecting portion provided between the first structure fixed portion and the first structure protruding portion, the first structure connecting portion connecting the first structure protruding portion to the first structure fixed portion,
a first structure gap exists between the base and the first structure protruding portion in the first direction.

5. The sensor according to claim 4, wherein
the first structure protruding portion includes:
a first end portion, and
a first intermediate portion between the first structure connecting portion and the first end portion,
a first end height of the first end portion relative to the base is higher than a first intermediate portion height of the first intermediate portion relative to the base.

6. The sensor according to claim 4, wherein
a position of the first structure protruding portion in the second direction is between a position of the first structure fixed portion in the second direction and a position of the first detecting portion in the second direction.

7. The sensor according to claim 1, wherein
the first structure includes a first insulating layer and a first layer overlapping the first insulating layer.

8. The sensor according to claim 1, further comprising:
a second structure fixed to the base,
the first detection section is between the first structure and the second structure in the second direction, and
the second structure overlaps the first element portion in the second direction.

9. The sensor according to claim 8, wherein
the second structure has a second structure height relative to the base,
the first element portion has a first element portion height relative to the base, and
the second structure height is higher than the first element portion height.

10. The sensor according to claim 8, wherein
the first detection section further includes a fixed portion fixed to the base and supports the first element portion, and
the fixed portion has a fixed portion height relative to the base,
the second structure has a second structure height relative to the base, and
the second structure height is higher than the fixed portion height.

11. The sensor according to claim 8, wherein
the second structure includes:
a second structure fixed portion fixed to the base,
a second structure protruding portion, and
a second structure connecting portion provided between the second structure fixed portion and the second structure protruding portion, the second structure connecting portion connecting the second structure protruding portion to the second structure fixed portion, and
a second structure gap exists between the base and the second structure protruding portion in the first direction.

12. The sensor according to claim 11, wherein
the second structure protruding portion includes
a second end portion, and
a second intermediate portion between the second structure connecting portion and the second end portion, and
a second end height of the second end portion relative to the base is higher than a second intermediate portion height of the second intermediate portion relative to the base.

13. The sensor according to claim 11, wherein
a position of the second structure protruding portion in the second direction is between a position of the first detecting portion in the second direction and a position of the second structure fixed portion in the second direction.

14. The sensor according to claim 8, further comprising:
a third structure fixed to the base; and
a fourth structure fixed to the base,
the first detection section is between the third structure and the fourth structure in a third direction, and
the third direction crosses a plane including the first direction and the second direction.

15. The sensor according to claim 1, wherein
a state of a detection target around the first element portion is configured to be detected based on a value corresponding to a change in a first electrical resistance of the first conductive member when a first other current is supplied to the first other conductive member.

16. The sensor according to claim 2, further comprising:
a second detection section,
in the second direction, the first structure is between the second detection section and the first detection section,
the second detection section includes a second detection element portion, the second detection element portion including a first resistance member, a second resistance member, and an intermediate conductive member,
the first structure overlaps the second detection element portion in the second direction, and
an intermediate conductive member position in the second direction is between a first resistance member position in the second direction of the first resistance member and a second resistance member position in the second direction of the second resistance member.

17. The sensor according to claim 16, further comprising:
a fifth structure fixed to the base,
the second detection section is between the fifth structure and the first detection section in the second direction,
a fifth structure height of the fifth structure relative to the base is lower than the first structure height.

18. The sensor according to claim 16, wherein
a second signal corresponding to a flow velocity of a detection object passing around the second detection section is configured to be detected based on a difference between a first resistance member electrical resistance of the first resistance member and a second resistance member electrical resistance of the second resistance member when an intermediate conductive member current is supplied to the intermediate conductive member.

19. The sensor according to claim 18, further comprising:
a controller,
a first signal corresponding to a concentration of the detection target around the first detection section being configured to be detected based on a value according to a change in a first electrical resistance of the first conductive member when a first other current flows through the first other conductive member,
the controller being configured to perform at least one of a first operation or a second operation,
the first operation including correcting the first signal based on the second signal, and
the second operation including correcting the second signal based on the first signal.

20. The sensor according to claim 16, further comprising:
a housing including a first opening and a second opening,
a detection device including the first structure, the first detection section, and the second detection section being placed in a space inside the housing, and
a position of the detection device in the second direction being between a position of the first opening in the second direction and
a position of the second opening in the second direction.
